(19) United States
(12) Patent Application Publication
(10) Pub. No.: US 2026/0059057 A1
(43) Pub. Date: Feb. 26, 2026

(54) IMAGE PROCESSING APPARATUS, CONTROL METHOD, AND STORAGE MEDIUM

(71) Applicant: CANON KABUSHIKI KAISHA, Tokyo (JP)

(72) Inventor: SHINICHI CHIBA, Tokyo (JP)

(21) Appl. No.: 19/288,470

(22) Filed: Aug. 1, 2025

(30) Foreign Application Priority Data
Aug. 20, 2024 (JP) 2024-139286

(51) Int. Cl. H04N 1/00

(52) U.S. Cl. CPC H04N 1/00411; H04N 1/00076; H04N 1/00509

(57) ABSTRACT

An image processing apparatus receives an input of a key code, determines whether the key code is a first key code to execute a first function mode or a second key code to execute a second function mode, displays a screen related to the first function mode in a case where it is determined that the received key code is the first key code, displays a screen related to the second function mode in a case where it is determined that the received key code is the second key code, wherein a history screen including information about the first function mode having been executed is displayed.

### BACKGROUND

### Field of the Technology

Exemplary embodiments of the present disclosure relate to an image processing apparatus, a control method, and a storage medium.

### Description of the Related Art

In the case of a failure or a malfunction of an image processing apparatus, repair or maintenance work is carried out either by a repair professional, i.e., service technician, who is requested to do so or by a user. Service technicians have specialized knowledge about repairs, but users are not necessarily familiar with repairs. In addition, a malfunctioning apparatus may become more damaged if the apparatus is not handled properly during the repair work. Thus, the scope of repair or maintenance work that a service technician is allowed to carry out generally differs from the scope of repair or maintenance work that a user is allowed to carry out.

Japanese Patent Application Laid-Open No. 2016-137691 discusses a method for handling errors where a flag is set indicating whether both a service technician and a user can perform a procedure to handle the error, and if the flag is not set, the execution of the procedure is permitted to a service technician alone.

In Japanese Patent Application Laid-Open No. 2016-137691, the scope of repair or maintenance work that allows a user to perform in a repair function for users (hereinafter, referred to as a repair mode) is more limited than in a repair function for service technicians (hereinafter, referred to as a service mode), reducing the risk of user's erroneous operations.

There is still a possibility that malfunctions of the apparatus may occur due to erroneous operations by general users who are not familiar with repair or maintenance of the apparatus. Thus, there has been a demand for providing an environment in which, in the case of a malfunction, the cause of the malfunction can be identified early on.

### SUMMARY

The present disclosure is directed to improving usability in repair or maintenance work of an image processing apparatus performed by a user.

According to an aspect of the present disclosure, an image processing apparatus comprising at least one memory storing a program and at least one processor, which when executes the program, causes the image processing apparatus to receive an input of a key code, determine whether the received key code is a first key code to execute a first function mode or a second key code to execute a second function mode different from the first function mode, display a screen related to the first function mode in a case where it is determined that the received key code is the first key code, display a screen related to the second function mode in a case where it is determined that the received key code is the second key code, wherein a history screen including information about the first function mode having been executed is displayed.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are block diagrams illustrating a configuration of an image processing apparatus according to a first exemplary embodiment.

FIGS. 2A and 2B are diagrams describing a key code input method according to the first exemplary embodiment.

FIGS. 3A to 3C are diagrams illustrating screens displayed in a service mode and a repair mode according to the first exemplary embodiment.

FIG. 4 is a flowchart illustrating a process of displaying an input error notification screen according to the first exemplary embodiment.

FIG. 5 is a flowchart illustrating a process of displaying a history screen in the repair mode according to the first exemplary embodiment.

FIGS. 6A and 6B are diagrams illustrating history screens according to a second exemplary embodiment.

### DESCRIPTION OF THE EMBODIMENTS

The present disclosure will now be described in detail with reference to the drawings. The following exemplary embodiments do not limit the present disclosure, and not all of combinations of features of the exemplary embodiments are necessarily essential to the solution of the present disclosure. In the accompanying drawings, like reference numbers refer to like components, and redundant descriptions are omitted.

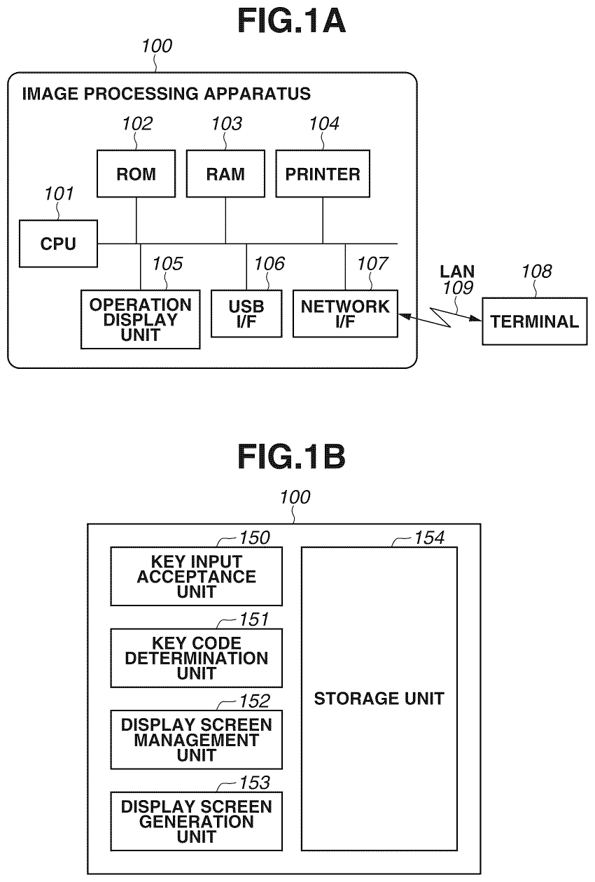

A first exemplary embodiment will now be described. FIGS. 1A and 1B are diagrams illustrating a configuration of an image processing apparatus 100 according to the first exemplary embodiment. FIG. 1A is a hardware block diagram of the image processing apparatus 100, and FIG. 1B is a software block diagram of the image processing apparatus 100.

In FIG. 1A, the image processing apparatus 100 is a multi-function peripheral (MFP) and includes a central processing unit (CPU) 101, a read-only memory (ROM) 102, a random-access memory (RAM) 103, a printer 104, and an operation display unit 105. The image processing apparatus 100 also includes a universal serial bus (USB) interface (I/F) 106 and a network I/F 107 as communication interfaces with devices external to the image processing apparatus 100.

The CPU 101 is a system control unit that controls the entire image processing apparatus 100. The ROM 102 stores a control program for the CPU 101. The control program executes each process of the present exemplary embodiment described below. The ROM 102 may be a rewritable flash ROM or the like, and stores setting values registered by the user of the image processing apparatus 100, management data, and the like. Time zone setting is saved in the ROM 102. The control program can be updated by an external input, which is referred to as a software version upgrade in the present exemplary embodiment. After the software is upgraded, the content that controls the CPU 101 differs from that of the previous version.

The RAM 103 stores execution programs, program control variables, various work buffers, some setting values registered by the user of the image processing apparatus 100, management data, and the like. The printer 104 records received images and file data on a recording medium. The operation display unit 105 includes a numeric keypad, a keyboard, a touch panel, a liquid crystal display (LCD), a light emitting diode (LED), and the like, and receives various operations by the user, displays operation screens, and provides notifications to the user. In the present exemplary embodiment, key code inputs can be performed, for example, using a keyboard (software keys) on a liquid crystal touch panel. Various screens are displayed on the touch panel.

The USB I/F 106 performs connection, communication, power supply, and the like with USB devices.

The network I/F 107 performs data transmission and reception between a terminal 108 and each unit of the image processing apparatus 100 via a local access network (LAN) 109 (i.e., a wireless LAN or a wired LAN). The communication method used to connect each device is the IEEE 802.11 series communication standards (Wi-Fi®) or Bluetooth® (Bluetooth® Classic, Bluetooth® Low Energy (BLE), or the like). The terminal 108 in the present exemplary embodiment is a smartphone, a tablet, a personal computer (hereinafter, referred to as a PC), or the like. The terminal 108 includes a touch panel and a keyboard function for operation, and enables the user to perform inputs and outputs.

In FIG. 1B, a key input acceptance unit 150 receives key inputs from the image processing apparatus 100. A storage unit 154 stores the key inputs received by the key input acceptance unit. The storage unit 154 also stores information, for example, on the use of a repair mode (a first function mode) by the user, and the dates and the times when the repair mode was used. Recording the received key inputs and storing information on the use of the repair mode may be handled by separate units. A key code determination unit 151 refers to the storage unit 154 to determine whether a key code is input. A display screen management unit 152 determines the screen contents to be displayed based on the determination by the key code determination unit 151. A display screen generation unit 153 generates screen information to be displayed in response to an instruction from the display screen management unit 152. The display screen management unit 152 performs display control for screen display based on the screen information generated by the display screen generation unit 153.

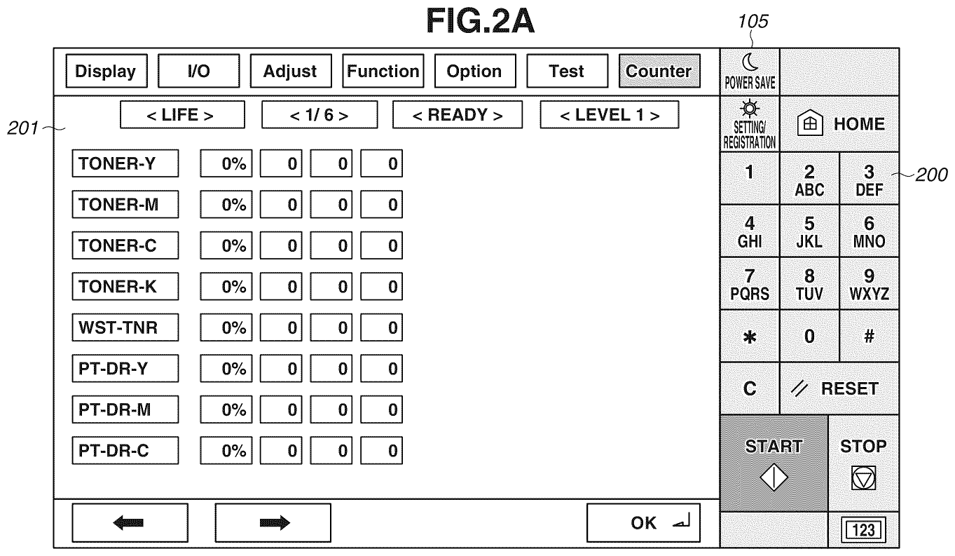

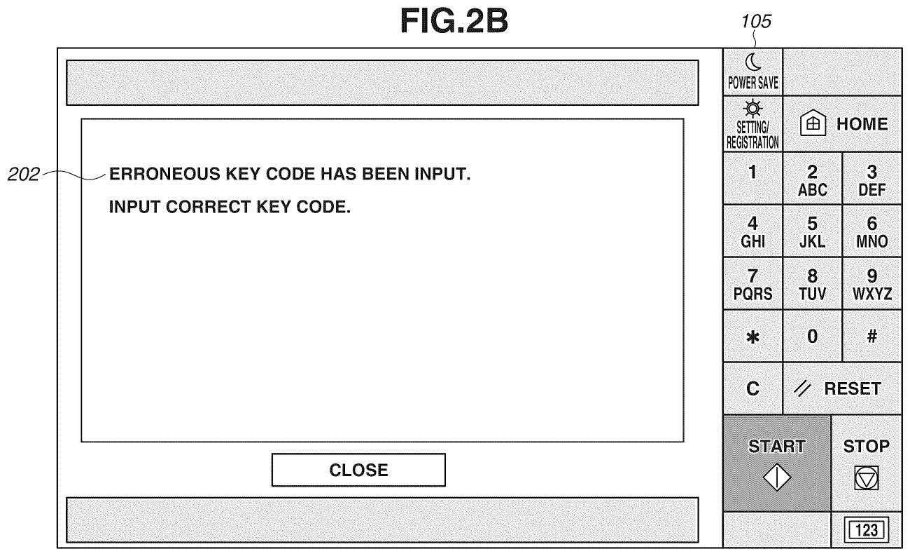

FIGS. 2A and 2B are diagrams describing a key code input method according to the present exemplary embodiment. In the present exemplary embodiment, a key code can be input using a liquid crystal touch panel included in the operation display unit 105. FIG. 2A illustrates an example of a screen displayed on the liquid crystal touch panel. The liquid crystal touch panel does not have fixed operation keys, and thus, the display screen management unit 152 displays a key area 200 and a display area 201 on the liquid crystal screen as illustrated in FIG. 2A. The user inputs the key code using the keys in the key area 200.

In the present exemplary embodiment, when eleven keys are input in a fixed order, such as #, 4, 7, 2, 3, 5, 7, 5, 9, 8, and #, the key code determination unit 151 determines that a key code for the repair mode (a first key code) is input. Then, the display screen management unit 152 displays a screen for the repair mode so that the user can use the repair mode function. A key code (a second key code) for a service mode (a second function mode) is set different from the key code for the repair mode, where the keys #, 5, 8, 3, 4, 6, 8, 6, 1, 9, and # are successively input in that order.

When the key code for the repair mode is correctly entered, the display screen management unit 152 displays a repair item screen in the display area 201. This enables the user to recognize that the repair mode function is called. In the repair mode, as illustrated in FIG. 2A, the repair item screen displayed in the display area 201 illustrates items indicating an amount of consumption or a wear level of each consumable part currently installed in the image processing apparatus 100. The user performs the necessary repair work according to the numerical values of these items, or changes the setting value of each item according to the work performed. This screen is also displayed in the service mode, and the information indicated by the items is as follows:
TONER-Y: Yellow toner wear level (an amount of consumption)
TONER-M: Magenta toner wear level (an amount of consumption)
TONER-C: Cyan toner wear level (an amount of consumption)
TONER-K: Black toner wear level (an amount of consumption)
WST-TNR: Waste toner accumulation level
PT-DR-Y: Yellow drum wear level
PT-DR-M: Magenta drum wear level
PT-DR-C: Cyan drum wear level

In the present exemplary embodiment, a key code input is received on any screen displayed in the operation display unit 105 of the image processing apparatus 100. For example, a key code input is received on any screen, such as the screen displayed immediately after the startup, the menu screen on which icons for calling the functions of the image processing apparatus 100 are arranged, the setting screen for specific items (for example, copy, print, facsimile (fax), and the like). Then, if the key code determination unit 151 determines that the correct key code is input, the display screen management unit 152 displays a screen for the function corresponding to the key code.

If the key code determination unit 151 determines that the key code for the repair mode is input incorrectly, the display screen management unit 152 displays a screen notifying an input error on a display screen 202 as illustrated in FIG. 2B. In the present exemplary embodiment, the input error notification screen is displayed as illustrated in FIG. 2B only when an error exists in the input of the key code for calling the repair mode. Thus, even if the key code for the service mode is input incorrectly, the input error notification screen is not displayed. This is because it is considered that service technicians are familiar with the operation of the image processing apparatus 100 and can take an appropriate action, such as re-inputting the key code. The input error notification screen in FIG. 2B is displayed when an error exists in the input of the key code to enter the repair mode and perform repair or maintenance work by the user, but can also be applied to key code inputs for calling other functions prepared for the user.

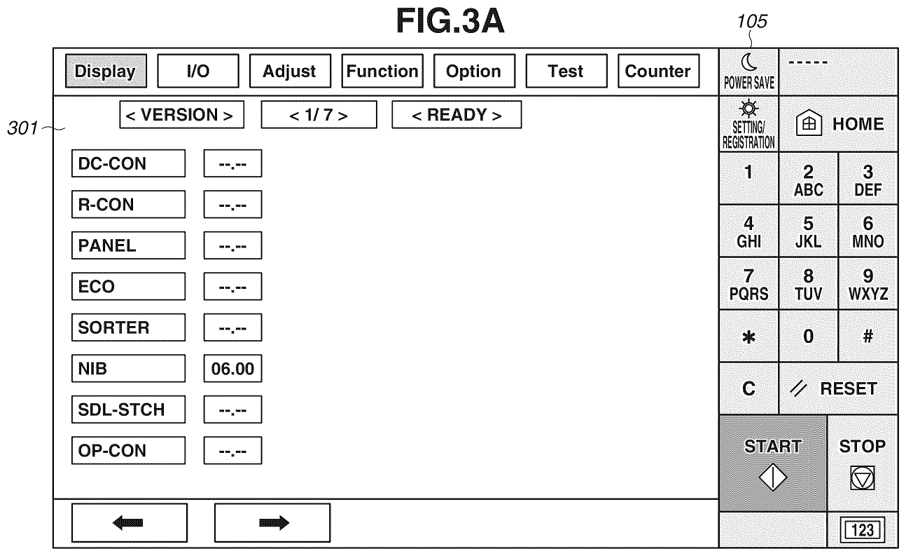

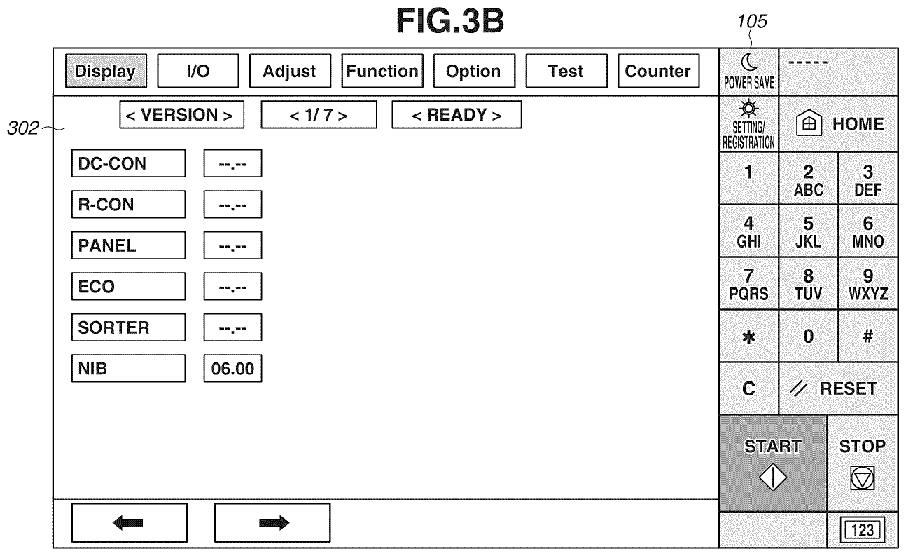

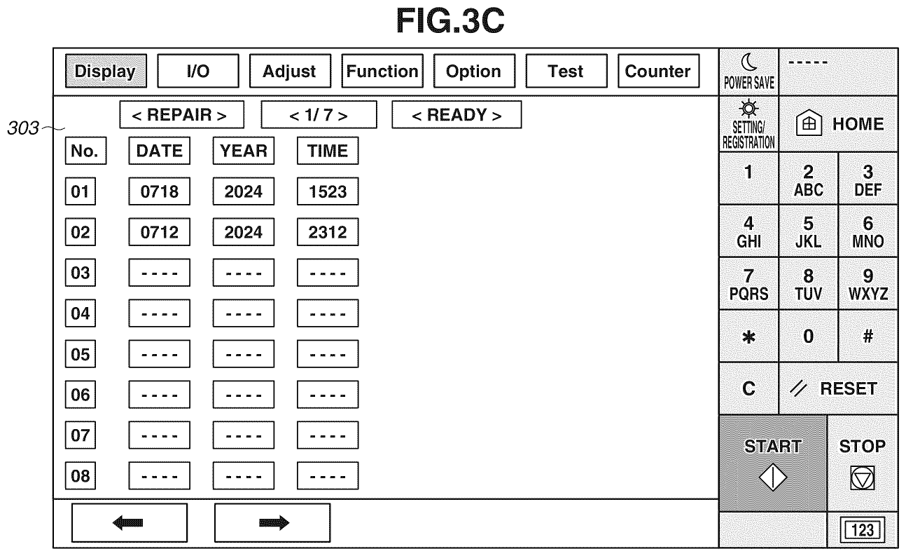

FIGS. 3A to 3C are diagrams illustrating screens displayed in the service mode and the repair mode in the present exemplary embodiment. In these drawings, a service mode screen 301 and a repair mode screen 302 are displayed in the service mode and the repair mode, respectively, at the time of performance of specific repair or maintenance work.

The service mode screen 301 is used in a service technician's performing repair or maintenance work. The screen is displayed when the service technician inputs the key code for the service mode and operates the service mode to perform repair or maintenance work. The service technician collects information necessary for the repair and takes a necessary measure while viewing and operating items (such as “DC-CON”) displayed on the service mode screen 301. The service technician presses a button (such as “Adjust”) at the top of the screen to change the displayed items as necessary depending on the work to be performed.

In FIG. 3A, the information indicated by the items displayed on the service mode screen 301 is as follows:
DC-CON: Software version of the installed print processing controller
R-CON: Software version of the installed scanner processing controller
PANEL: Software version of the installed operation panel processing controller
ECO: Software version of the installed controller that handles confidential information
SORTER: Software version of the installed first sorting controller
NIB: Software version of the installed network processing controller
SDL-STCH: Software version of the installed second sorting controller
OP-CON: Software version of the installed optional function controller

For any of the above items, if no controller is installed or if information cannot be obtained due to some error, a hyphen is displayed.

As illustrated in FIG. 3B, the repair mode screen 302 is also displayed to perform repair or maintenance work. While the screens 301 and 302 are both displayed in performing the same repair work, differences exist between the displayed contents of screens 301 and 302. For example, the repair mode screen 302 does not include items below the display item “NIB” on the service mode screen 301.

FIG. 3C is a diagram describing a history screen 303 in the present exemplary embodiment. The history screen 303 describes the dates and the times when the use of the repair mode function was started. The history screen 303 is displayed when the user returns to the previous level in the hierarchy from the service mode screen 301 by pressing the reset key and selects the item “REPAIR” displayed therein.

In the history screen 303, the “No.” column indicates the order of the recordings, the “DATE” column indicates the dates of the recordings, the “YEAR” column indicates the years of the recordings, and the “TIME” column indicates the times of the recordings.

Thus, it can be understood that the repair mode was last called at 15:23 on Jul. 18, 2024. Each time the repair mode is called, the date and the time are recorded at the top, and the earlier dates and times move down one in the columns. If the date and the time are not recorded, the unrecorded state is displayed as “-”. The history screen 303 enables the user to check the dates and times when the repair mode function was started. The history screen 303 is not displayed in the repair mode. The history screen 303 is displayed when a user performs an operation to access the history screen 303 in the service mode.

The present exemplary embodiment is not limited to this implementation, and the history screen 303 can be displayed from the repair mode.

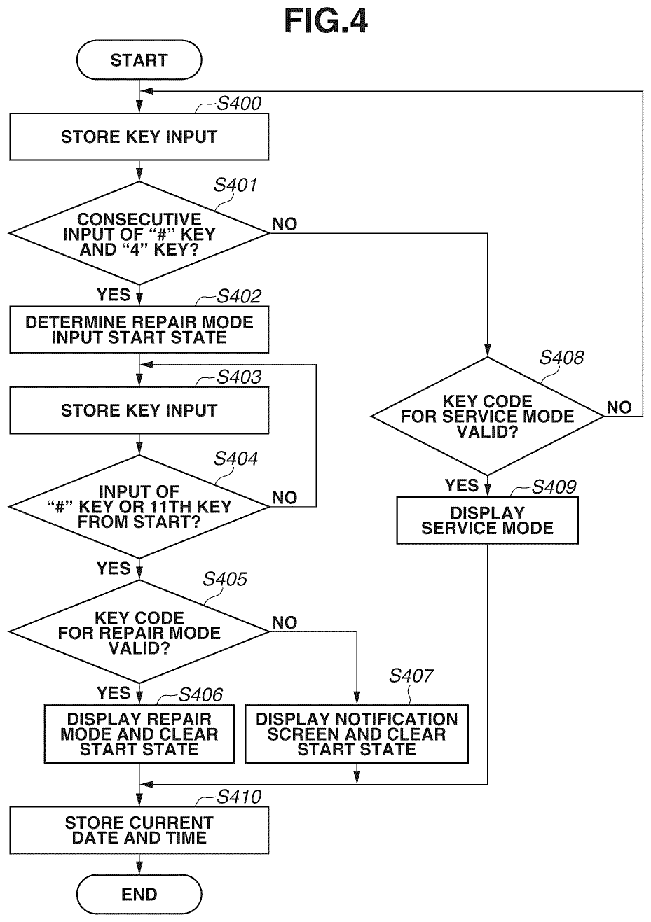

FIG. 4 is a flowchart illustrating a process of displaying the input error notification screen at the input of the key code in the repair mode in the present exemplary embodiment. The process in the flowchart starts in response to the start of a key input by the user on the liquid crystal touch panel of the image processing apparatus 100 to perform repair or maintenance work. The process in the flowchart is performed by the CPU 100 reading programs into the RAM 103 for implementing control modules stored in the ROM 102 to execute the programs. Some or all of the functions of steps of FIG. 4 can be carried out by hardware, such as an Application Specific Integrated Circuit (ASIC) or an electronic circuit.

In step S400, the storage unit 154 stores a key input received by the key input acceptance unit 150. In step S401, when the first two keys (the first two digits) of the key code are input, the storage unit 154 stores the first two keys. The key code determination unit 151 determines whether the first two keys consecutively input are the “#” key and the “4” key. If the key code determination unit 151 determines that the consecutively input first two keys of the input key code are the “#” key and the “4” key (YES in step S401), the process proceeds to step S402.

In step S402, the key code determination unit 151 determines that an input of the key code for the repair mode is started, and sets the start state of a key code input for the repair mode. In the present exemplary embodiment, the key code for the repair mode is set different from the key code for the service mode, and at least keys corresponding to the first predetermined number of keys (two in the present exemplary embodiment) are different. This enables the key code determination unit 151 to determine that an input of the key code for the repair mode is started based on the keys corresponding to the first predetermined number of keys input.

In step S403, the storage unit 154 stores one key input received by the key input acceptance unit 150, and the process proceeds to step S404. In step S404, the key code determination unit 151 determines whether the key input stored in the storage unit 154 in step S403 is the “#” key, or whether the number of times keys have been input since the start of the key input has reached eleven. If the result of the determination in step S404 is negative (NO in step S404), the process returns to step S403. In step S403, the storage unit 154 stores the next input key.

In step S404, if the key code determination unit 151 determines that the “#” key is input or that the number of times keys have been input has reached eleven (YES in step S404), the process proceeds to step S405. Thus, in step S404, the key code determination unit 151 determines that the user completes the input of the key code based on an input of the last key (the last digit) of the correct key code for the repair mode or inputs corresponding to the number of keys of the correct key code for the repair mode.

In step S405, the key code determination unit 151 determines whether the input key code is valid. In other words, the key code determination unit 151 determines whether the input key code stored in the storage unit 154 in steps S401 and S403 is the correct key code for the repair mode. If the key code determination unit 151 determines that the key code input in step S405 is the correct key code for the repair mode (YES in step S405), the process proceeds to step S406. If the key code determination unit 151 determines that the input key code is not the correct key code for the repair mode (NO in step S405), the process proceeds to step S407.

In step S406, the display screen management unit 152 displays a screen for the repair mode on the liquid crystal panel and clears the start state. In step S407, the display screen management unit 152 displays the input error notification screen 202 and clears the start state. In step S410, the storage unit 154 records and stores the date and the time at this point. The information on the dates and the times when the service mode was started, which is stored in step S410, can be checked on the history screen 303.

If the key code determination unit 151 determines in step S401 that the consecutively input first two keys of the key code are not the “#” key and the “4” key (NO in step S401), the process proceeds to step S408. In step S408, the key code determination unit 151 determines whether the input key code is valid for the service mode. If it is determined in step S408 that the input key code is valid for the service mode (YES in step S408), the process proceeds to step S409. The display screen management unit 152 then displays a screen for the service mode on the liquid crystal panel.

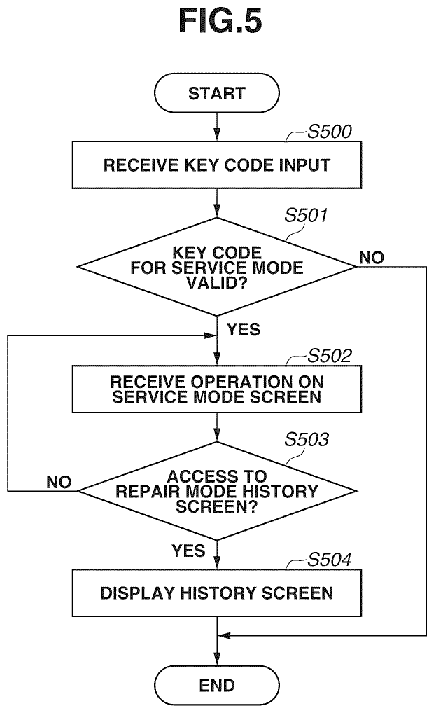

FIG. 5 is a flowchart illustrating a process of displaying the repair mode history screen 303 in the present exemplary embodiment. The process in the flowchart is performed by the CPU 100 reading programs from the ROM 102 for implementing control modules into the RAM 103 to execute the programs.

The process in the flowchart of FIG. 5 starts based on a key input from any screen, such as the screen immediately after the startup, the menu screen, or the setting screen for a specific item (for example, copy, print, fax, or the like). In step S500, the key input acceptance unit 150 receives the input of a key code. In step S501, the key code determination unit 151 determines whether the key code received by the key input acceptance unit 150 is the key code for the service mode. If the result of the determination in step S501 is positive (YES in step S501), the process proceeds to step S502. If the result is negative (NO in step S501), the process in the flowchart ends. In step S502, the display screen management unit 152 receives a user operation on the service mode screen. In step S503, the display screen management unit 152 determines whether the user operation to access the history screen 303 is performed on the service mode screen. If the display screen management unit 152 determines that the user operation to access the history screen 303 is performed (YES in step S503), the process proceeds to step S504. In step S504, the display screen management unit 152 displays the history screen 303.

As described above, according to the present exemplary embodiment, since the dates and the times when the user used the repair mode can be identified, an environment can be provided in which, even if a malfunction occurs in the image processing apparatus 100 due to repair or maintenance work, the cause of the malfunction can be identified in an early stage. This improves usability in repair or maintenance work of the image processing apparatus performed by the user.

A second exemplary embodiment will now be described. In the first exemplary embodiment, the dates and the times when the user used the repair mode are displayed on the history screen 303. In the present exemplary embodiment, more detailed information is displayed on the history screen 303. The more detailed information includes, for example, the contents of processing performed by the user in the repair mode and names of the users who have logged in at the executions of the repair mode. The same reference numerals are assigned to the described components of the first exemplary embodiment, and redundant descriptions are be omitted.

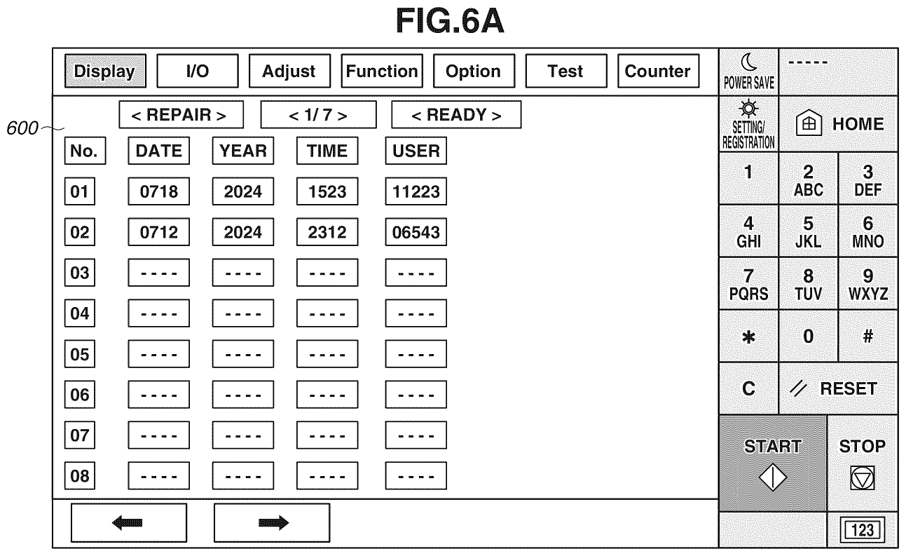

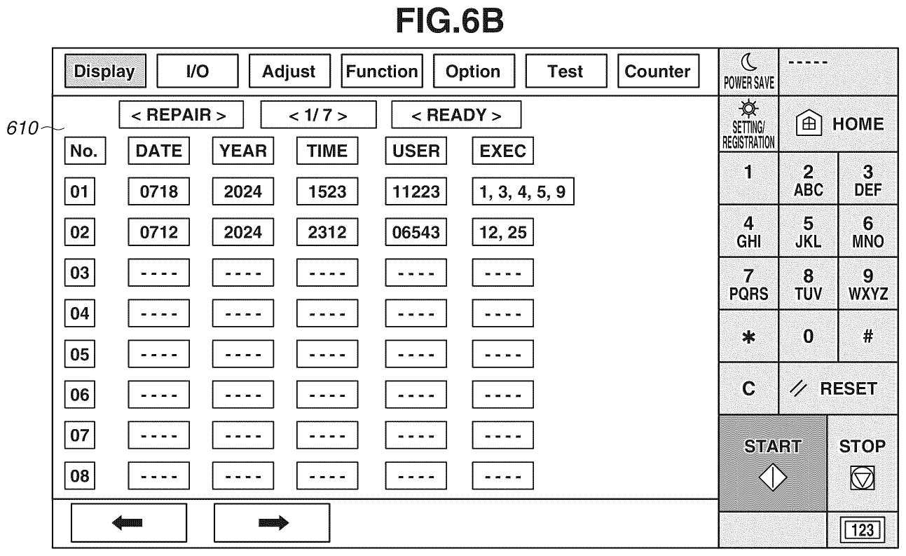

FIGS. 6A and 6B are diagrams illustrating history screens in the present exemplary embodiment. FIG. 6A is a diagram illustrating a history screen 600 accessed from the repair mode. The history screen 600 displays, in addition to the dates and the times when the repair mode was used, information on the users who accessed at those times under an item “USER”. The history screen 600 displays the user information in the form of a user ID that identifies the user.

FIG. 6B is a diagram illustrating a history screen 610 accessed from the service mode. In the present exemplary embodiment, the method of accessing the history screen 600 or 610 is the same in the service mode and in the repair mode. The history screen 610 or 610 is displayed by selecting an item “REPAIR” from the display hierarchy.

In addition to the information on the history screen 600 displayed in the repair mode, the history screen 610 has an additional item “EXEC” that indicates the contents of work performed by the user. The item “EXEC” indicates what repair or maintenance work was performed when the repair mode was accessed. Specifically, the processing item numbers for the repairs or maintenance work performed are displayed in a list, and the display area extends to the right based on the number of times repair or maintenance work has been performed. The processing item numbers are linked to the contents of repair or maintenance work and, for example, the numbers beginning from one are associated with the maintenance contents displayed on a certain repair screen in order from the top.

For example, if a user enters the repair mode and performs repair or a maintenance work with items numbered one, three, four, five, and nine in that order, “1, 3, 4, 5, 9” are displayed as in the first row of the history screen 610 in FIG. 6B. If the sequence of the processes executed is changed, the display is changed in the same manner. For example, if the execution of the processes with items numbered one and four are interchanged, “4, 3, 1, 5, 9” are displayed.

It is not necessary to display all the information on the history screens 600 and 610 illustrated in FIGS. 6A and 6B. Some part of the information alone may be displayed. In the present exemplary embodiment, the history screen 610 displayed in the service mode contains more information than the history screen 600 displayed in the repair mode. However, the history screen in the service mode and the history screen in the repair mode may be the same. As in the first exemplary embodiment, the history screen can be displayed in the service mode alone, and the history screen may not be displayed in the repair mode.

According to the present exemplary embodiment, a history screen is displayed to provide information about the users who have used the repair mode and the contents of the processes performed in the repair mode, in addition to the dates and the times when the users used the repair mode. This enables identifying the cause of a malfunction in the image processing apparatus 100 from various kinds of information, which improves usability in repair or maintenance work of the image processing apparatus performed by a user.

### Other Exemplary Embodiments

The above-described exemplary embodiments can also be implemented by executing the following processes. Software (programs) for implementing the functions of the above-described exemplary embodiments may be supplied to a system or an apparatus via a network or various storage media, and a computer (a CPU, a micro processing unit (MPU), or the like) of the system or the apparatus reads and executes the programs. The programs can be executed by a single computer, or can be executed by a plurality of computers in cooperation with each other. All or some of the processes may be performed by hardware, such as an Application Specific Integrated Circuit (ASIC). A single CPU may perform all of the processes, and a plurality of CPUs may perform the processes while coordinating with each other as appropriate.

The functions of the above-described exemplary embodiments are carried out by executing the program codes read by a computer. In addition, an operating system (OS) running on a computer performing some or all of the processes based on instructions of the program codes to carry out the functions of the above-described exemplary embodiments is included.

Usability can be improved in repair or maintenance work of an image processing apparatus performed by a user.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-139286, filed Aug. 20, 2024, which is hereby incorporated by reference herein in its entirety.

What is claimed is:

1. An image processing apparatus comprising:
at least one memory storing a program; and
at least one processor, which when executes the program, causes the image processing apparatus to:
receive an input of a key code;
determine whether the received key code is a first key code to execute a first function mode or a second key code to execute a second function mode different from the first function mode; and
display a screen related to the first function mode in a case where it is determined that the received key code is the first key code,
display a screen related to the second function mode in a case where it is determined that the received key code is the second key code,
wherein a history screen including information about the first function mode having been executed is displayed.

2. The image processing apparatus according to claim 1, wherein the history screen includes information about a date and a time when the execution of the first function mode was started.

3. The image processing apparatus according to claim 2, wherein the history screen further includes information about contents of processes executed in the first function mode and information about a user who executed the first function mode.

4. The image processing apparatus according to claim 3, wherein the information about the contents of the processes executed in the first function mode is displayed based on a sequence of the executed processes.

5. The image processing apparatus according to claim 1, wherein the history screen is not displayed in a state where the first function mode is executed and displayed in a state where the second function mode is executed.

6. The image processing apparatus according to claim 1, wherein the history screen is displayed in a state where the first function mode is executed and in a state where the second function mode is executed.

7. The image processing apparatus according to claim 6, wherein fewer types of information contained in the history screen are displayed in a state where the first function mode is executed than in a state where the second function mode is executed.

8. The image processing apparatus according to claim 1, wherein the first key code and the second key code are different from each other.

9. The image processing apparatus according to claim 1, wherein fewer types of functions are executable in the first function mode than in the second function mode.

10. The image processing apparatus according to claim 1, wherein the first function mode is a mode for a user to perform repair or maintenance work of the image processing apparatus and the second function mode is a mode for a service technician to perform repair or maintenance work of the image processing apparatus.

11. The image processing apparatus according to claim 1, wherein the input of the key code is received in a case where a displayed screen is at least one of a screen immediately after a startup, a menu screen, or a setting screen.

12. A method of controlling an image processing apparatus, the method comprising:
receiving an input of a key code;
determining whether the received key code is a first key code to execute a first function mode or a second key code to execute a second function mode different from the first function mode; and
displaying a screen related to the first function mode in a case where the received key code is determined to be the first key code,
displaying a screen related to the second function mode in a case where the received key code is determined to be the second key code,
wherein a history screen including information about the first function mode having been executed is displayed.

13. A non-transitory computer readable storage medium storing a program which causes a computer to execute a method, the method comprising:
receiving an input of a key code;
determining whether the received key code is a first key code to execute a first function mode or a second key code to execute a second function mode different from the first function mode; and
displaying a screen related to the first function mode in a case where the received key code is determined to be the first key code,
displaying a screen related to the second function mode in a case where the received key code is determined to be the second key code,
wherein a history screen including information about the first function mode having been executed is displayed.
